(19) United States
(12) Patent Application Publication
(10) Pub. No.: US 2014/0216840 A1
(43) Pub. Date: Aug. 7, 2014

(54) DRIVELINE FOR A VEHICLE, VEHICLE WITH SUCH A DRIVELINE AND METHOD OF CONTROLLING A DRIVELINE OF A VEHICLE

(71) Applicants: Russell Osborn, Warwick (GB); Ian Beverley, Warwick (GB); Brett Hallam, Moreton in Marsh (GB); Steve Mullane, Southam (GB); Mark Rathbone, Leamington Spa (GB); Shaun Wick, Solihull (GB)

(72) Inventors: Russell Osborn, Warwick (GB); Ian Beverley, Warwick (GB); Brett Hallam, Moreton in Marsh (GB); Steve Mullane, Southam (GB); Mark Rathbone, Leamington Spa (GB); Shaun Wick, Solihull (GB)

(73) Assignee: JAGUAR LAND ROVER LIMITED, Whitley Coventry Warwickshire (GB)

(21) Appl. No.: 14/233,849

(22) PCT Filed: Jul. 19, 2012
(86) PCT No.: PCT/EP2012/064201

§ 371 Date: Apr. 7, 2014

(30) Foreign Application Priority Data
Jul. 19, 2011 (GB) 1112414.6

(51) Int. Cl. B60K 17/34; B60K 17/348

(52) U.S. Cl. CPC B60K 17/34; B60K 17/348
USPC 180/248; 180/233

(57) ABSTRACT

A driveline for a vehicle such that a first group of one or more wheels and not a second group may be driven by prime mover means when the driveline is in a first mode of operation and the second group of one or more wheels may additionally be driven by the prime mover means when the driveline is in a second mode of operation, the driveline comprising: an auxiliary driveshaft; a power transfer unit (PTU) operable by means of PTU actuator means releasably to drivably couple the auxiliary driveshaft to the prime mover means; and a releasable drive unit operable by means of drive unit actuator means releasably to drivably couple the auxiliary driveshaft to the second group of one or more wheels, the PTU actuator means and drive unit actuator means each being powered by means of a pressurised fluid medium, the fluid medium being pressurised by a common pressurisation means.

### FIELD OF THE INVENTION

The present invention relates to a system, to a motor vehicle including such a system and to a method of controlling a motor vehicle. In particular but not exclusively the invention relates to systems for #motor vehicles such as all-terrain vehicles (ATVs) having a driveline that is operable to change the number of wheels that provide torque to drive the vehicle. Aspects of the invention relate to a system, to a vehicle and to a method.

### BACKGROUND

It is known to provide a motor vehicle having a four wheel drive mode of operation in which motive power is supplied to each of two pairs of wheels of the vehicle. Motive power is supplied to the wheels by means of a driveline.

Some known vehicles are arranged such that motive power is permanently supplied to both pairs of wheels. Some other vehicles are arranged such that motive power is selectively supplied to either only one pair of wheels (in a two wheel drive mode of operation) or to both pairs of wheels (in a four wheel drive mode of operation). Some such systems allow the portion of the driveline transmitting power to the second pair of wheels to come to rest when in the two wheel drive mode thereby reducing parasitic losses.

GB2407804 discloses a dynamic driveline reconnect arrangement in which reconnection of two of the wheels to the driveline following disconnection of the wheels from the driveline may be undertaken when the vehicle is moving. Such a system may be referred to as a dynamic driveline reconnect (or disconnect) system. The system disclosed in GB2407804 employs clutch arrangements to enable dynamic driveline reconnection.

It is an aim of embodiments of the present invention to provide an improved dynamic driveline system.

### STATEMENT OF THE INVENTION

Embodiments of the present invention may be understood by reference to the appended claims.

According to one aspect of the invention for which protection is sought there is provided a system for a vehicle comprising a driveline operable to releasably connect a prime mover to first and second groups of one or more wheels of the vehicle such that the first group of one or more wheels is driven by the prime mover means when the driveline is in a first mode of operation and the second group of one or more wheels is additionally driven by the prime mover means when the driveline is in a second mode of operation, the system comprising an auxiliary driveshaft, a power transfer unit (PTU) operable by means of PTU actuator means releasably to couple the auxiliary driveshaft to the prime mover means and a releasable drive unit operable by means of drive unit actuator means releasably to couple the auxiliary driveshaft to the second group of one or more wheels, the PTU actuator means and drive unit actuator means each being actuated by a common hydraulic system

According to another aspect of the invention for which protection is sought there is provided a system for a vehicle comprising a driveline operable to releasably connect a prime mover to first and second groups of one or more wheels of the vehicle such that the first group of one or more wheels is driven by the prime mover means when the driveline is in a first mode of operation and the second group of one or more wheels is additionally driven by the prime mover means when the driveline is in a second mode of operation, the system comprising an auxiliary driveshaft, a power transfer unit (PTU) operable by means of PTU actuator means releasably to couple the auxiliary driveshaft to the prime mover means and a releasable drive unit operable by means of drive unit actuator means releasably to couple the auxiliary driveshaft to the second group of one or more wheels, the PTU actuator means and drive unit actuator means each being powered by means of a pressurised fluid medium, the fluid medium being pressurised by a common pressurisation means.

In embodiments, the PTU actuator means and the drive unit actuator means are fed with a pressurised fluid from a common pressurised fluid source.

In a further aspect of the invention for which protection is sought there is provided a system comprising:
prime mover means;
at least first and second groups of one or more wheels; and
a driveline operable releasably to connect the prime mover means to the first and second groups of one or more wheels such that the first group of one or more wheels is arranged to be driven by the prime mover means when the driveline is in a first mode of operation and the second group of one or more wheels is additionally arranged to be driven by the prime mover means when the driveline is in a second mode of operation,
the driveline including an auxiliary portion comprising:
an auxiliary driveshaft;
a power transfer unit (PTU) operable by means of PTU actuator means releasably to drivably couple the auxiliary driveshaft to the prime mover means; and
a releasable drive unit operable by means of drive unit actuator means releasably to drivably couple the auxiliary driveshaft to the second group of one or more wheels,
wherein the PTU actuator means and drive unit actuator means are each arranged to be powered by means of a pressurised fluid medium, the fluid medium being pressurised by a common pressurisation means.

In another aspect of the invention for which protection is sought there is provided a driveline for a vehicle such that a first group of one or more wheels and not a second group may be driven by prime mover means when the driveline is in a first mode of operation and the second group of one or more wheels may additionally be driven by the prime mover means when the driveline is in a second mode of operation, the driveline comprising:
an auxiliary driveshaft;
a power transfer unit (PTU) operable by means of PTU actuator means releasably to drivably couple the auxiliary driveshaft to the prime mover means; and
a releasable drive unit operable by means of drive unit actuator means releasably to drivably couple the auxiliary driveshaft to the second group of one or more wheels, the PTU actuator means and drive unit actuator means each being powered by means of a pressurised fluid medium, the fluid medium being pressurised by a common pressurisation means.

Thus, the PTU actuator means and drive unit actuator means are each powered by pressurised fluid medium from the same pressurisation means.

Embodiments of the invention have the advantage that it is not necessary to provide separate respective pressurisation means for the PTU actuator means and drive unit actuator means.

Furthermore, by employing pressurised fluid to actuate the PTU and drive unit, electromechanical actuators are not required to be employed. Electromechanical actuators have the disadvantage that electromagnetic interference (EMI) can be induced by the actuators and power control lines associated with the actuators in other electrical circuits and systems of the vehicle. The EMI generated may be not insubstantial due to the large currents required to provide sufficient power to actuate the actuators.

Use of electromechanical actuators is particularly disadvantageous in vehicles having a PTU and releasable drive unit since electrical power lines must be run between a driveline controller and each of the PTU and releasable drive unit in order to provide power to actuate the PTU and releasable drive unit. This typically entails the running of electrical control lines along a substantial length of the vehicle, close to other electrical cables of the vehicle, inducing undesirable EMI in the cables. Embodiments of the present invention overcome this problem by actuating both the PTU and the releasable drive unit by means of a pressurised fluid.

Thus, substantially no EMI is generated by the actuators or control lines since they carry pressurised fluid and not electrical currents. Furthermore, any EMI that may be generated by a compressor pressurising the fluid may be limited to a single location of the vehicle. This location may be chosen to be one where EMI is not of particular concern.

As noted above, the pressurised fluid is provided by a single source. In some arrangements this allows an enhancement in efficiency of the vehicle. In some embodiments use of a single source enables a reduction in weight of the vehicle, and in some embodiments a reduction in complexity of hardware of the vehicle.

The common pressurisation means may comprise compressor means.

The compressor means may comprise a compressor device.

The common pressurisation means may comprise a fluid storage reservoir, the pressurisation means being arranged to compress fluid in the fluid storage reservoir.

The PTU may comprise releasable torque transmitting means operable by means of the PTU actuator means to couple the auxiliary driveshaft to the prime mover means.

In an embodiment, the releasable torque transmitting means of the PTU comprises a power transfer clutch.

The second group of one or more wheels may comprise a plurality of wheels.

The releasable drive unit may comprise releasable torque transmitting means operable by means of the drive unit actuator means to drivably couple the auxiliary driveshaft to the second group of one or more wheels.

In an embodiment, the releasable torque transmitting means of the releasable drive unit comprises at least one releasable torque transmitting device.

The releasable torque transmitting means of the releasable drive unit may comprise a plurality of releasable torque transmitting devices.

In an embodiment, the releasable torque transmitting means of the releasable drive unit comprises a first releasable torque transmitting device operable to transmit torque to a first wheel of the second group of wheels and a second releasable torque transmitting device operable to transmit torque to a second wheel of the second group of wheels.

This feature has the advantage that differential rates of rotation of the first and second wheels of the second group of wheels may be accommodated. For example differential rates of rotation may be accommodated by slip of one or both of the devices.

Thus the releasable torque transmitting means of the drive unit allows disconnection of the rear wheels from the auxiliary driveline as well as differential rates of rotation of the first and second wheels when the first and second wheels are being driven by the auxiliary driveline.

It is to be understood that an arrangement in which two or more clutches are provided, such that one clutch is employed to drive a first wheel on one side of a vehicle and another clutch is employed to drive a second wheel on the opposite side of the vehicle may be referred to as a ‘twin clutch’ arrangement.

Advantageously the first and second releasable torque transmitting devices may be operable to accommodate differential rates of rotation between the first and second wheels of the second group of wheels.

Alternatively the vehicle may comprise a differential arrangement for accommodating differential rates of rotation between first and second wheels of the second group of wheels in addition to the releasable drive unit.

Thus the drive unit may be employed in a vehicle having a conventional differential, such as a differential having a ring gear arranged to drive a carrier which in turn drives respective side gears via a planet gear, the side gears being arranged to drive the first and second wheels of the second group of wheels.

Advantageously the at least one releasable torque transmitting device may comprise a clutch device.

Advantageously the releasable drive unit may comprise the common pressurisation means.

This feature has the advantage that an overall cost, weight and/or package space required in order to provide the releasable drive unit and common pressurisation means may be reduced.

Furthermore, in some embodiments this feature enables a modular approach to driveline feature provision to be facilitated. Thus, for drivelines not according to the present invention where a drive unit is provided that is not releasable, a drive unit may be provided without the common pressurisation means comprised thereby. For drivelines according to embodiments of the present invention in which a releasable drive unit is provided, the drive unit may be provided with the common pressurisation means.

Still furthermore, it is to be understood that where a driveline is provided in which engagement and disengagement of the second group of one or more wheels is controlled by the releasable drive means only and not by a releasable PTU (i.e. the PTU does not allow releasable coupling of the auxiliary driveline to and from the prime mover means), the common pressurisation means may be arranged to pressurise fluid for the releasable drive unit only. Thus, no pressurised fluid line need be run from the releasable drive unit to the PTU since the PTU does not have releasable torque transmitting means requiring power for actuation thereof.

Embodiments of the present invention therefore allow substantially the same releasable drive means to be employed in a vehicle having a releasable PTU (in which case a pressurised fluid line may be run from the releasable drive unit to the PTU) or a vehicle not having a releasable PTU (in which case a pressurised fluid line may not be run from the releasable drive unit to the PTU).

By combining the releasable drive unit and common pressurisation means in a single unit a requirement to find package space for the common pressurisation means at a location other than the releasable drive unit may be eliminated. This reduces a constraint on a vehicle designer in respect of package space for other components. In the case of a rear-mounted releasable drive unit, package space is at a premium due to a requirement to package other components associated with a driveline, and in addition engine exhaust aftertreatment systems and vehicle suspension components, whilst minimising reduction in ground clearance on the one hand and cabin space on the other.

A further advantage of employing a common pressurisation means for the releasable drive unit is that in embodiments having separate clutches for respective left and right rear wheels, if the pressurisation means fails whilst the clutches are closed, both clutches will suffer loss of fluid pressure and therefore assume an open condition. Such a unit may be considered to be ‘fail safe’ since (1) if only one clutch fails whilst the other is still closed, asymmetric torque application may result in respect of the left and right rear wheels causing vehicle instability; and (2) if a vehicle anti-lock braking system (ABS) becomes active, it is important that the ABS system be able independently to control torque application to each wheel of the vehicle.

It is to be understood that in the case of a driveline not having a differential, but rather a twin clutch arrangement in which one or more clutches are operable to disconnect a left wheel from the auxiliary driveshaft and one or more clutches are operable to disconnect a right wheel from the auxiliary driveshaft, it is important to release the left and right wheels from one another by means of one or more clutches of the twin clutch arrangement so that rotation of a left wheel is not constrained by rotation of a right wheel. It is to be understood that, in the absence of a differential, the twin clutch arrangement tends to constrain rotation of respective left and right wheels such that they must rotate together at the same speed, unless sufficient differential torque is applied between the respective wheels, for example whilst cornering. Release of a constraint to relative movement of left and right wheels allows the ABS system to enjoy two degrees of freedom in respect of control of left and right rear wheels.

A further advantage of integrating the releasable drive unit and common pressurisation means is that a length of pressurised fluid lines between the pressurisation means and releasable torque transmitting means of the drive unit may be kept relatively short, and of substantially equal length. Thus when it is required to coordinate application of differential pressure between releasable torque transmitting devices servicing respective left and right wheels (in the case of a ‘twin clutch’ releasable drive unit arrangement), accurate control of an amount of pressure applied to each of the devices may be ensured. This may be particularly important in stability control systems (SCS) where asymmetric torque application may be required.

The releasable drive unit and pressurisation means may be provided in a common package, optionally a common housing.

In a further aspect of the invention for which protection is sought there is provided a vehicle comprising a driveline according to any preceding aspect or embodiment.

Optionally the prime mover means comprises an engine.

The prime mover means may comprises a plurality of prime movers.

Alternatively or in addition the prime mover means may comprises an electric motor.

For example in the case of a hybrid electric vehicle the prime mover means may comprise an engine or other fuel burning propulsion motor and an electric motor.

According to a further aspect of the invention for which protection is sought there is provided a method of controlling a driveline whereby a first group of one or more wheels and not a second group may be driven by prime mover means when the driveline is in a first mode of operation and the second group of one or more wheels may additionally be driven by the prime mover means when the driveline is in a second mode of operation, the method comprising connecting an auxiliary driveshaft of an auxiliary driveline to the prime mover means by actuating actuator means of a power transfer unit (PTU) thereby to allow the second group of wheels to be connected to the prime mover means; and connecting the auxiliary driveshaft to the second group of one or more wheels by actuating actuator means of a releasable drive unit, the step of actuating actuator means of the PTU and releasable drive unit actuator means comprising providing pressurised fluid medium to the respective actuator means from a common pressurisation means.

In an embodiment, the step of actuating respective actuator means comprises the step of actuating clutch means.

The step of providing pressurised fluid medium to the respective actuator means from a common pressurisation means may comprise providing pressurised fluid medium to the respective actuator means from a single pressurisation means.

The step of providing pressurised fluid medium advantageously comprises providing pressurised fluid medium from common pressurisation means comprised by the releasable drive unit.

In one aspect of the present invention there is provided a releasable drive unit for a driveline, the releasable drive unit being operable by means of drive unit actuator means releasably to drivably couple an auxiliary driveshaft to a group of one or more wheels, the drive unit comprising fluid pressurisation means for pressurising fluid for actuating the drive unit actuator means.

Thus embodiments of the invention provide a drive unit having means for pressurising fluid for powering actuator means for coupling the auxiliary driveshaft to the group of one or more wheels. The releasable drive unit may be operable by means of drive unit actuator means releasably to drivably couple the auxiliary driveshaft to the one or more wheels by means of a releasable torque transmitting means, optionally clutch means. The clutch means may comprise dry clutch means, wet clutch means and/or any other suitable clutch means. The releasable drive means and fluid pressurisation means may be accommodated in a common housing, alternatively they may be coupled to one another not in a common housing. The fluid pressurisation means may be operable to provide pressurised fluid to an external unit such as a power transfer unit (PTU) for releasably coupling the driveshaft to an output of a transmission or the like.

Within the scope of this application it is envisaged that the various aspects, embodiments, examples and alternatives set out in the preceding paragraphs, in the claims and/or in the following description and drawings, and particularly the individual features thereof, may be taken independently or in any combination. For example, features described in connection with one embodiment are applicable to all embodiments, unless such features are incompatible.

### BRIEF DESCRIPTION OF THE DRAWINGS

Embodiments of the invention will now be described, by way of example only, with reference to the accompanying figures in which:

FIG. 1 is a schematic illustration of a driveline of a known vehicle having a power transfer unit and rear differential unit;

FIG. 2 is a schematic illustration of a driveline of a vehicle according to an embodiment of the present invention; and

FIG. 3 is a schematic illustration of a hydraulic fluid control unit of the vehicle of FIG. 2.

### DETAILED DESCRIPTION

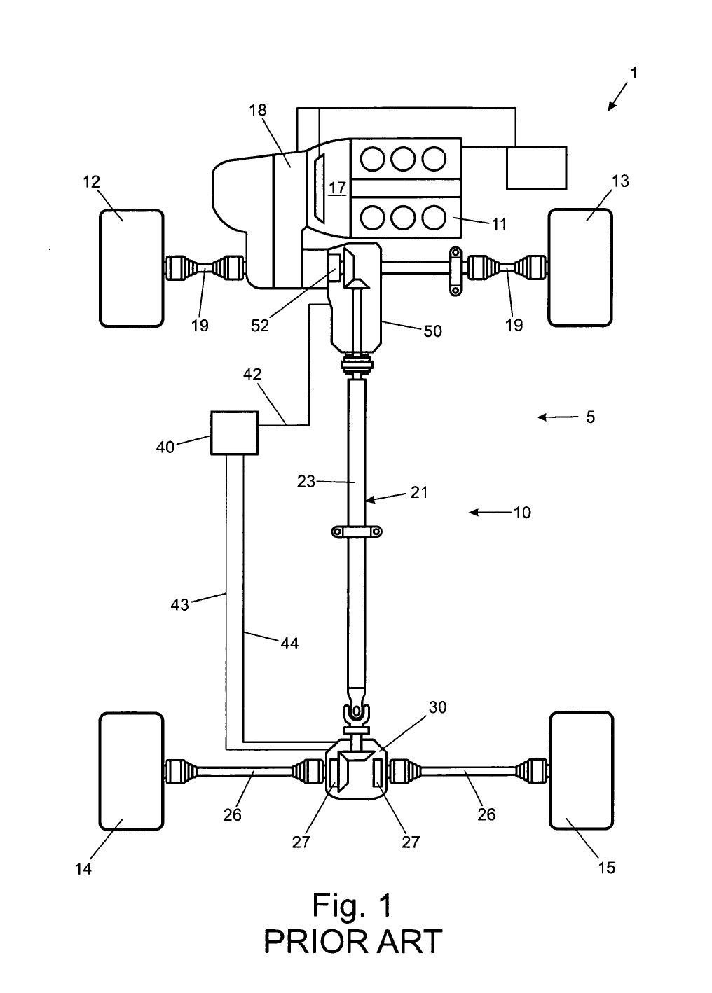

FIG. 1 shows a driveline 5 of a known motor vehicle 1. The driveline 5 is connected to an internal combustion engine 11 by means of a gearbox 18 and has a pair of front wheels 12, 13, an auxiliary driveline portion 10 and a pair of rear wheels 14, 15. The auxiliary driveline portion 10 forms part of the driveline 5, but may also be referred to as an ‘auxiliary driveline 10’. Its purpose is to convey drive torque to rear wheels 14, 15 of the vehicle 1 when required.

The driveline 5 is arranged selectively to transmit power supplied to it by the gearbox 18 from the internal combustion engine 11 to the front wheels 12, 13 only (in a first mode of operation also referred to as a two wheel drive mode of operation) or to the front wheels 12, 13 and the rear wheels 14, 15 simultaneously (in a second mode of operation also referred to as a four wheel drive mode of operation).

Power is transmitted from the internal combustion engine 11 to the front wheels 12, 13 by means of a clutch 17, a gearbox 18 and a pair of front drive shafts 19.

Power is transmitted to the rear wheels 14, 15 by means of the auxiliary driveline 10. The auxiliary driveline 10 has a power transfer unit (PTU) 50 having releasable torque transmitting means in the form of a power transfer clutch (PTC) 52 operable to connect a drive shaft 23 of the auxiliary driveline 10 to the gearbox 18. The drive shaft 23 may also be referred to as an auxiliary drive shaft 23.

The PTC 52 is in the form of a multi-plate wet clutch (MPC). An electromechanical actuator (not shown) is arranged to open and close the PTC 52.

The auxiliary drive shaft 23 is coupled in turn to a rear drive unit (RDU) 30 operable to couple the auxiliary drive shaft 23 to the rear drive shafts 26. The RDU 30 has releasable torque transmitting means in the form of a pair of clutches 27 actuated by respective electromechanical actuators (not shown). The RDU 30 is thereby operable to connect the auxiliary draft shaft 23 to the rear drive shafts 26 when the four wheel drive mode of operation is required. When the clutches 27 are closed, the RDU 30 accommodates differential rates of rotation of the rear wheels 14, 15 by slippage of one or both of the clutches 27.

The driveline 5 has a driveline controller 40 arranged to control operation of the actuators of the PTC 52 and clutches 27. A PTC power cable 42 provides power from the controller 40 to the actuator of the PTC 52 whilst left and right actuator power cables 43, 44 respectively power left and right actuators of the RDU 30.

When a four wheel drive mode of operation is required the controller 40 is arranged to power the actuator of the PTC 52 to close the PTC 52 and to power the actuators of the clutches 27 of the RDU 30 to close the clutches 27.

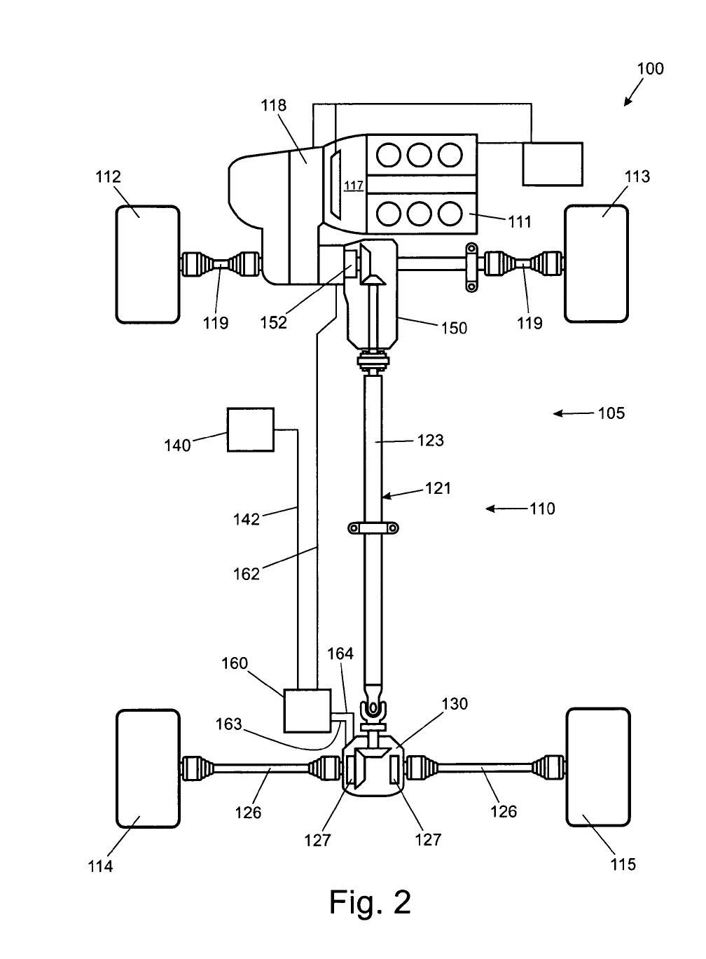

FIG. 2 shows a portion of a vehicle 100 according to an embodiment of the present invention. Like features of the vehicle 100 of FIG. 2 to that of the vehicle 1 of FIG. 1 are labelled with like reference numerals incremented by 100.

The vehicle 100 differs from the vehicle 1 of FIG. 1 in that actuators of the PTC 152 of PTU 150 and clutches 127 of the RDU 130 are powered by hydraulic fluid supplied by a hydraulic fluid control unit 160. The control unit 160 is coupled in fluid communication with the PTC 152 by means of a PTC hydraulic fluid control line 162. The control unit 160 is coupled in fluid communication with RDU 130 by means of a left clutch control line 163 and a right clutch control line 164.

In some embodiments the control unit 160 is fixedly coupled to the RDU 130 by means of a rigid coupling thereby to prevent relative movement between the control unit 160 and RDU 130. This feature has the advantage that a risk of failure of control lines 163, 164 due to fatigue or other wear of may phenomenon induced by such relative movement may be reduced. In some embodiments the control unit 160 shares a common housing with the RDU 130.

It is to be understood that an advantage of siting the control unit 160 with or as part of the RDU 130 has the advantage that a response of the clutches 127 of the RDU to a change in pressure of fluid in a hydraulic line 163, 164 may be made faster than in the case of a control unit 160 sited remotely from the RDU 130. This has the advantage that if it is required to disconnect the auxiliary driveshaft 123 from the rear wheels 114, 115 quickly in an emergency a process of disconnection may be accomplished swiftly. It is to be understood that emergency disconnection may be required for example in the event an ABS system of the vehicle 100 becomes active, since independent control of a speed of each wheel 112, 113, 114, 115 is required in order to perform ABS braking most effectively. Other brake-based stability control features of systems may also benefit from an ability of the driveline 105 to assume the two wheel drive mode of operation relatively quickly.

Furthermore, because a length of the hydraulic lines 163, 164 is relatively short, synchronisation of opening and closing of twin clutches 127 may be performed such that the clutches 127 open and close substantially together. This has the advantage that a risk that one clutch opens or closes before the other, resulting in asymmetric torque distribution between respective left and right rear wheels 114, 115 is reduced.

The control unit 160 is configured to generate a pressure of hydraulic fluid sufficient to actuate the PTC 152 to connect and disconnect the auxiliary driveshaft 123 to and from the gearbox 118 when required. In addition, the control unit 160 generates a sufficient pressure of fluid to actuate left and right clutches 127 of the RDU 130 to connect and disconnect the auxiliary driveshaft 123 to and from the rear wheels 114, 115 when required.

In the embodiment of FIG. 2 the control unit 160 is provided at a rearward location of the vehicle 100. This feature has the advantage that an overall length of hydraulic fluid lines 162, 163, 164 may be reduced compared to a situation in which the control unit 160 is located at a forward location of the vehicle 100, since two fluid lines 163, 164 are required to couple to the RDU 130.

The hydraulic fluid control unit 160 is arranged to receive operational commands from the driveline controller 140 to open and close one or more of the clutches 152, 127 as required. The driveline controller 140 provides relatively low-power control signals to the control unit 160 by means of an electrical control cable 142 such that an amount of any electromagnetic interference (EMI) generated by control signals transmitted by the cable 142 is not significant, and substantially less than in the case of cables powering electrically actuated clutch systems. In some arrangements control signals are provided to the control unit 160 by means of a network such as a controller area network (CAN) bus or the like.

Embodiments of the present invention have the advantage that, because hydraulic actuators are employed rather than electromechanical actuators, substantially no EMI is generated by the actuators when the PTC 152 or clutches 127 are opened or closed.

Furthermore, a single control unit 160 is employed to provide pressurised hydraulic fluid to actuate the PTC 152 and RDU clutches 127. This has the advantage that an auxiliary driveline 110 may be provided having reduced weight and package space requirements compared with known drivelines employing electromagnetic actuators.

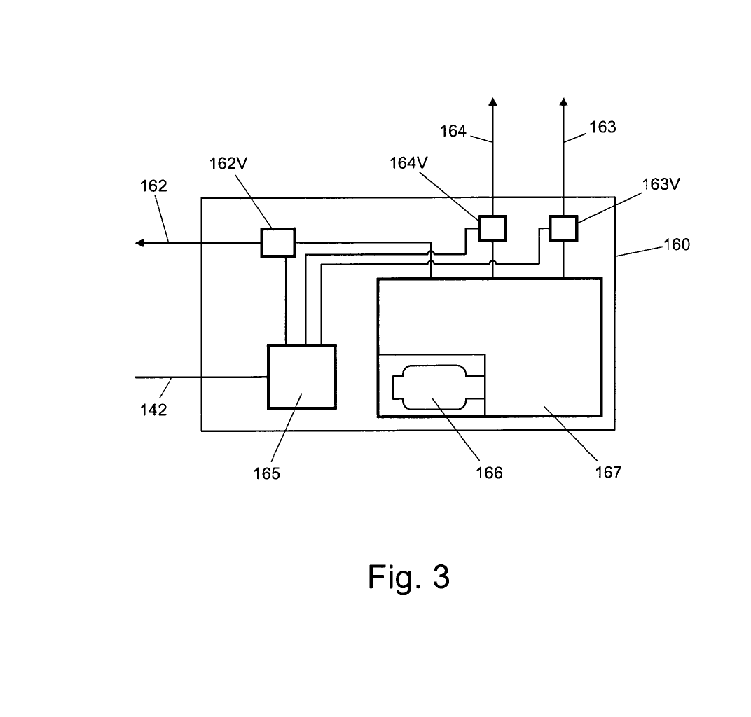

A layout of the control unit 160 of the embodiment of FIG. 2 is shown schematically in FIG. 3. The control unit 160 has a compressor 166 arranged to compress hydraulic fluid in a fluid reservoir 167. The reservoir 167 is in fluid communication with actuators of the PTC 152 and left and right clutches 127 of the RDU 130 via respective valves 162V, 163V, 164V. A controller module 165 of the control unit 160 is arranged to receive control signals from the driveline controller 140 via the control cable 142. The controller module 165 opens and closes the valves 162V, 163V, 164V as commanded by the controller 140 in order to actuate the PTC 152 and clutches 127.

In some arrangements the fluid reservoir 167 may be referred to as an accumulator. The compressor 160 may be configured to maintain a pressure of hydraulic fluid in the reservoir 167 above a prescribed level in order to allow substantially instant provision of pressurised fluid to the hydraulic fluid lines 162, 163, 164 when a respective valve 162V, 163V, 164V is opened.

Other arrangements are also useful. In some embodiments the compressor 166 is arranged to be energised when it is required to actuate the PTC 152 or clutches 127 in order to supply the required pressure of hydraulic fluid. This feature has the advantage that a risk that a pressure of hydraulic fluid falls to a level that reduces a rate of actuation of a clutch is reduced.

It is to be understood that embodiments of the invention in which actuators of the PTU 150 and RDU 130 are actuated by means of hydraulic fluid from a single source are also useful in vehicles in which an engine is provided at a rear of the vehicle instead of or in addition to a front of the vehicle as shown in FIG. 2. In some arrangements the PTU may be provided at a rearward location of the vehicle whilst the RDU 130 is provided at a forward location of the vehicle (and may therefore be described as a forward drive unit, FDU or the like).

It is to be understood that in some embodiments an auxiliary releasable drive unit may be provided that is separate from the rear drive unit (or forward drive unit), the auxiliary releasable drive unit being arranged to releasably connect the auxiliary driveshaft to the RDU or FDU. In some such arrangements the auxiliary releasable drive unit may have a single releasable torque transmitting means.

The auxiliary releasable drive unit may optionally be connected to the RDU or FDU by a further driveshaft. It is to be understood that in some arrangements the RDU or FDU may comprise a conventional differential arrangement for accommodating differential rates of rotation of respective wheels driven by the RDU or FDU, rather than clutches as described herein with respect to the RDUs 30, 130 of the vehicles of FIG. 1 and FIG. 2. In arrangements having an RDU or FDU having a conventional differential arrangement, the provision of a separate auxiliary releasable drive unit comprising a releasable torque transmitting means for releasably coupling the auxiliary driveshaft to the differential may be particularly useful. Alternatively in some arrangements an RDU or FDU having a differential arrangement may be arranged to accommodate a releasable torque transmitting means in addition. The releasable torque transmitting means is arranged to be actuated by hydraulic fluid from the same source as the PTU, whether provided integral to the RDU or as a separate auxiliary releasable drive unit.

It is to be understood that whilst reference is made to an RDU or FDU a unit may be provided at any suitable location of a vehicle, for example in a substantially middle region of a vehicle with respect to a length or at any suitable location forward or rearward of that location.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A driveline for a vehicle configured or arranged such that a first group of one or more wheels and not a second group may be driven by prime mover means when the driveline is in a first mode of operation and the second group of one or more wheels may additionally be driven by the prime mover means when the driveline is in a second mode of operation, the driveline comprising:
a driveshaft;
a power transfer unit (PTU) operable by means of PTU actuator means to releasably couple the driveshaft to the prime mover means; and
a drive unit operable by means of drive unit actuator means to releasably couple the driveshaft to the second group of one or more wheels;
wherein the PTU actuator means and drive unit actuator means are each driven by means of a pressurized fluid medium, the fluid medium being pressurized by a common pressurization means.

2. A driveline as claimed in claim 1 wherein the common pressurization means comprises compressor means.

3. (canceled)

4. A driveline as claimed claim 1 wherein the common pressurization means comprises a fluid storage reservoir, the pressurization means being arranged to compress fluid in the fluid storage reservoir.

5. A driveline as claimed in claim 1 wherein the PTU comprises releasable torque transmitting means operable by means of the PTU actuator means to couple the driveshaft to the prime mover means.

6-7. (canceled)

8. A driveline as claimed in claim 1 wherein the drive unit comprises releasable torque transmitting means operable by means of the drive unit actuator means to drivably couple the driveshaft to the second group of one or more wheels.

9. A driveline as claimed in claim 8 wherein the releasable torque transmitting means of the drive unit comprises a plurality of releasable torque transmitting devices, and the second group of one or more wheels comprises a plurality of wheels, wherein the releasable torque transmitting means of the drive unit comprises a first releasable torque transmitting device operable to transmit torque to a first wheel of the second group of wheels and a second releasable torque transmitting device operable to transmit torque to a second wheel of the second group of wheels.

10-11. (canceled)

12. A driveline as claimed in claim 9 wherein the first and second releasable torque transmitting devices are operable to accommodate differential rates of rotation between the first and second wheels of the second group of wheels.

13. A driveline as claimed in claim 9 wherein the plurality of releasable torque transmitting devices comprises a clutch device.

14. A driveline as claimed in claim 9 comprising a differential arrangement for accommodating differential rates of rotation between the first and second wheels of the second group of wheels.

15. A driveline as claimed in claim 1 wherein the drive unit comprises the common pressurization means.

16. A vehicle comprising a driveline as claimed in claim 1.

17-19. (canceled)

20. A method of controlling a driveline whereby a first group of one or more wheels and not a second group may be driven by prime mover means when the driveline is in a first mode of operation and the second group of one or more wheels may additionally be driven by the prime mover means when the driveline is in a second mode of operation,
the method comprising drivably coupling an auxiliary driveshaft to the prime mover means by actuating actuator means of a power transfer unit (PTU); and
drivably coupling the auxiliary driveshaft to the second group of one or more wheels by actuating actuator means of a releasable drive unit,
the step of actuating actuator means of the PTU and releasable drive unit actuator means comprising providing pressurized fluid medium to the respective actuator means from a common pressurization means.

21. A method as claimed in claim 20 wherein the step of actuating respective actuator means comprises the step of actuating clutch means.

22. A method as claimed in claim 20 wherein the step of providing pressurized fluid medium comprises providing pressurized fluid medium from the common pressurization means comprised by the releasable drive unit.

23. A method as claimed in claim 20 wherein the step of providing pressurized fluid medium to the respective actuator means from a. common pressurization means comprises providing pressurized fluid medium to the respective actuator means from a single pressurization means.
